(19) United States
(12) Patent Application Publication
(10) Pub. No.: US 2014/0180474 A1
(43) Pub. Date: Jun. 26, 2014

(54) "Method for distribution, vending and replacement of goods through automatic vending machines installed on board of vehicles of public transportation (VT); automatic vending machines and equipment for installation of automatic vending machines on vehicles public transportation".

(71) Applicant: Jairo Silva SOARES, Sao Paulo (BR)

(72) Inventor: Jairo Silva SOARES, Sao Paulo (BR)

(21) Appl. No.: 14/100,648

(22) Filed: Dec. 9, 2013

(30) Foreign Application Priority Data
Dec. 10, 2012 (BR) 10 2012 031394

(51) Int. Cl. G07F 11/00

(52) U.S. Cl. CPC G07F 11/002
USPC 700/236

(57) ABSTRACT

An operating method for vending of goods in automatic vending machines developed to be placed on board of vehicles of public transportation, such as city buses or long distance buses, subway cars, trains, vessels, places and any locations of human busy movement; the replacement of machines or goods through a method for managing the vending including the storage logistics and distribution of goods, and a method for installing and uninstalling the machines of public transportation.

### FIELD OF THE INVENTION

This invention is in the field of vending machines and distribution and commercialization of goods through vending machines in means of public transportation, which are mobile points of sale (MPOS).

### BACKGROUND OF THE INVENTION

As is well-known by the professionals in the area of automatic vending machines, there is an increasing common reality in populations of big and mid-sized cities around the world. The vending machines show and make several goods available for human choice, within a wide range of products, generally with a low-cost and in a quick and direct way, through a multiple choice.

This is a worldwide trend. The current automatic vending machines, in addition to offering a multitude of candies products, snacks and beverages, it also offer other kinds of goods, such as books, condoms, cell phones, toys, among others. through a variety of payment methods, that could be through traditional coins or bank notes, as well as by means of magnetic card and other. The operations for selling products through the vending machines involve a group of individuals whose participations are specified in each stage of this process. To sum up, the individuals in charge of a usual operation of goods sale through the vending machines are as follows:
Manufacturer or Importer: To manufacture or import the machine and its parts and spare parts for replacement;
Operator: To purchase the machine and install it in third parties institutions, under leasing or lending, by promoting its periodic supply and its preventive and corrective maintenance;
Vendor of goods (manufacturer or distributor): To sell the products to be available in the machines, directly to the operator;
Clients: companies, offices, consulting companies (consultancy), hospitals, universities and others that execute an agreement of leasing or lending with the operator, for the installation of machines in the area of keen interest; and
Final Consumer: To withdraw product from the machine for final consumption.

As shown, the supply chain involved in the operation of vending machines, as a rule, foreseen that the same vending machines should be placed in fixed places and elsewhere people pass through, i.e., in the institutions of “clients”. This enable the final consumer to have an easy access and the “operators” could work under the machine operating logistics.

Although the machines are placed in, the institutions located in the busy area of consumers, due to daily rush, many times, the individuals choose not to stop in front of these institutions to purchase the products, even when there is the desire. This has happened increasingly more frequent, especially in big cities.

Throughout these years, the manufacturers of vending machines have been strongly committed to attract and draw the attention of consumers, as well as the manufacturers of products to be distributed. Hence the application of several technologies, that are related to the method of payment, and that are related to the sale control.

For instance, some automatic vending machines, in addition to traditional coins and bank notes, have reader devices for magnetic cards or other type of cards, such as of “approaching” card. As well as, most recently, some machine include devices that receive a payment notification through a message from cell phone apparatus, which make easy the sale and release of goods.

For the control of any automatic vending machine, most recently some of them have been equipped with a system used in mobile phones (GSM system or other), which is linked to device of prices, receiving (payment) and to the device of goods release, enabling the submission of information, either in real time or not, by this apparatus. This information is, e.g., data regarding the price collected by the apparatus and the amount of sold goods, among others.

However, even with all the technology known nowadays, the consumer is still resistant to the need of changing his/her direction (in the street, at stations, etc.) to purchase goods through the automatic vending machines. Hence the sale points of large consumption of goods through vending machines are found in places and locations of ‘await areas’, such us entrance room of hospitals, clinics, cars dealers and other places where the consumer is awaiting and with down time.

The world market of vending machines is getting bigger each year. The existing numbers in countries like the United States of America, Japan and some European countries shows that a million of vending machines are available for individuals, by distributing the most diversified kind of products and services. Therefore, it is estimated that the sale revenues already generate 250 billion of dollars per year.

In developed countries, the rate of market growth reaches out 20% per year. Every day, new users are viewed using the vending machines even in remote regions of the world and new apps of these machines are developed continuously. The expectations in the world market are increasingly better, with the reduction of equipment costs and through the access to new technologies that make its use easier (cards, cell phone, etc).

It is expected that the Brazilian market operates 45,000 vending machines, generating a sale revenue of around R$50 million [BRL]. This market is experiencing an increasing volume of business opportunities and demands mainly by means of innovations and spreading the use of traditional vending machines. The growth potential is huge in view of the increasing familiarity with the use of machines with a range of apps, especially upon by the business view that promote it. It passes from the initial phase of mere curiosity to the expansion phase, in which vending machines are placed as a continuous channel of distribution and sale of products directly to the consumers, by adding agility, hygiene, convenience and many other specific advantages to the system, already acknowledged by individuals and institutional consumers.

What is needed therefore is improvements in the sale market of vending machines, and a method which aims to take small automatic vending machines to vehicles of public transportation, such as buses, subways cars and trains, vessels and other places and locations regardless of its several existing models of transportation vehicles in order to offer goods to the passengers within the internal area of transport vehicle, where there is massive movement of people and passengers.

### SUMMARY OF THE INVENTION

This invention refers to an operating method for vending of goods and its replacement through the automatic vending machines. The invention also refers to a method that involves several operating stages and its control which include from the storage logistics and distribution of goods, to the mode of replacement of these sold products in the automatic vending machines or the replacement of the machines, which are developed to be placed on board of vehicles of human mass transport, such as city buses or long distance buses, subway cars, trains, vessels, places and any locations of human busy movement.

This invention refers to the manufacture of automatic vending machines to be used with the method of goods and its replacement through the automatic vending machines; and also refers to a method of installing and uninstalling the automatic vending machines in the vehicles.

### BRIEF DESCRIPTION OF DRAWINGS

FIG. 1 shows a system view for distribution, sale and replacement of goods through the automatic vending machines taken on board vehicles of public transportation.

FIG. 2 illustrates a schematic superior view of a city bus, where it is possible to view the installation of two automatic vending machines configured according to this invention.

FIG. 3 illustrates a schematic view of the interior of a vehicles of public transportation, as a bus, where it is illustrated an automatic vending machine fixed to the hand rail and is available to a passenger.

FIGS. 4, 4A and 4B illustrate, respectively, the front and posterior views assembled and posterior view exploded of a first model of automatic vending machine with the features desired under this invention, in which one option for bracket and lock item is composed of a hose clamp that has a device of switch and lock for the quick change of machines.

FIGS. 5, 5A and 5B represent, respectively, the front and posterior views assembled and the posterior view exploded of a second model of automatic vending machine, in which the support item is a kind of cradle which besides holding the machine, locks it through internal devices.

### DETAILED DESCRIPTION OF THE INVENTION

The method of the present invention includes the following main topics: i) sites of management of distribution and logistics for receiving and storing several goods coming from several manufacturers; ii) manufacturing of vending machines with its own configuration and appropriate to be taken on board and off board of vehicles of public or mass transportation; iii) logistics for assembling and installation of brackets in public transportation vehicles, in order to receive small and specific vending machines in the form to set up multiple mobile points of sale (also called Mobile Points of Sale—MPOS]); iv) means to control remotely the sale of goods in the MPOS in different sites of distribution and in real time, by having the data related to the collection of each vending machine, kind of sold goods, control of change/supply of each vending machine empty or partially empty by another one full of goods; v) providing replacement of the vending machines which are empty or partially empty of goods by other small and similar vending machines full of goods; using vehicles of supply (4), according to the data collected; vi) providing replacement or supply of goods to the automatic vending machines, at the sites of management.

As provided for in this system, the products duly positioned internally in the automatic vending machines, now designed to be taken on board of city transportation vehicle, are placed in designated site of distribution, i.e., once the vending machine is fixed in the transportation vehicle, when the amount of products in low or finished, emptying the machine, or when only part of its total capacity of available marketable products is completed; the same should be supplied or replaced by another one already supplied. This replacement happens through a qualified and trained person that boards into the transportation vehicle as a regular passenger, removes the vending machine from its locked location, preferably together with the rail of the vehicle, and places another machine integrally supplied, when getting off the vehicle with the empty or partially empty vending machine, which, in its turn, returns back to the site of distribution to be supplied again.

The replacement of products in the vending machines is only performed at the site of distribution. Once this procedure is carried out, the vending machine is locked again and will only be opened, during the following supply operation and maintenance processes to be implemented.

Thus, it is not only preserved the security regarding the patrimony of products taken on board, but mainly, all filled money in each vending machine is also preserved, because the operator that replaces the of machines has only the task of supplying the machines and does not have access to the cashbox, nor the part regarding the intelligence of the machine. This access is only performed by trained and qualified people and authorized by the site of distribution.

Preferably, every vending machine developed to attend the system of the present invention, is attached or carried by a bracket previously fixed to a rail or support within the transportation vehicle. The bracket can be a hose clamp with coupling lock or a cradle with lock, without needing to perform the change or interference in transportation vehicles. After the coupling in the bracket fixed to the hand rail, the vending machine, at any time, could be removed or changed through a special mechanism and security switch to enable the non-coupling.

Every vending machine has an apparatus that submits collected information by employing the mobile phone technology (GSM System or any other suitable one). The information may be submitted in real time (or alternatively recorded for near future use), ensuring the reading and data capture related to the information and goods sold, the time of sale, the sale numbers throughout the days and throughout the week, by type of transportation vehicle and identification showing that the machine is installed, etc. At the end, all the possible and necessary information can be used for the logistics, supply and stock system of marketable products and the availability of the goods.

The vending machine has a fixed battery internally and is loaded outside of the transport vehicle, preferably at the site of distribution, not being necessary, either if available, any intervention in the transport vehicle for capturing energy and operation.

At the site of distribution, all required information remotely available should be captured and analyzed for each vending machine. This information is used in the management of the operation chain, from the maintenance of its operation and also for all the processes related to the logistics of the distribution site, such as, products to be determined and purchased for supply, time of supply, time of replacement and/or replacement of machines, etc.

The present invention provides several edible goods to the consumers in vehicles of public transportation, by enabling an easy and quick access to candies and snacks. The goods can, even, be provided according to the time of population movement, such as products that attend the feeding in the morning (cookies and snacks, cereal bars with fruit, etc.) or in the evening or at night (nuts, snacks, filled wafer, cereal bars, chocolate, etc.).

The present invention provides also the sale of products through modern devices, in which the consumer has a short time to make the choice, payment and release of chosen product.

The present invention provides also for the quick replacement of machines at the MPOS, thus avoiding the troubles and disruption during the dislocation or travel of passengers, as the replacement of the machine is performed with the disassembly of empty or partially empty machine and the assembly of another machine full of products, therefore, a key with secret code and lock device.

The present invention provides also for the change of empty machine with a filled one, which is to avoid the manipulation of prices by the operator in front of people, and by preventing also any theft attempt. Specifically, the replacement of the machine is performed in a quick and safe way, because several vehicles of supply circulate all over the city with vending machines full of products. Then, when it is reported by the site of distribution, an employee gets in a vehicle of public transportation through the door, usually as any other passenger, unlocks the machine from its position, takes off and places another one in the location, gets off the vehicle through the exit door, as any other passenger, being, then, recovered by the vehicle of supply. The empty machines are taken back to the site of distribution for a new loading and thus, successively.

The present invention provides also for an automatic vending machine, as a whole. The machine is especially shaped for this purpose and it is presented, therefore, in small sizes (dimensions), rounded edges and appropriate shapes to avoid accident with individuals in the vehicles of public transportation on places of sales. The machines are installed in places and locations where it does not prevent or disturb the movement of passengers, even if the vehicle is with its maximum passengers capacity.

The present invention provides also for the data submission of sold goods in each MPOS, whereby it is possible to trace the parameters over the users' profile of that line of vehicle of public transportation, as well as the kind of goods more consumed in definite period during the day, by encouraging the change of goods, as well as, increasing sales.

The present invention provides also for the manufacturing automatic vending machines (2) constructed and arranged to be installed and uninstalled at any other appropriate places of sale (PDV) or mobile points of sale (MPOS);

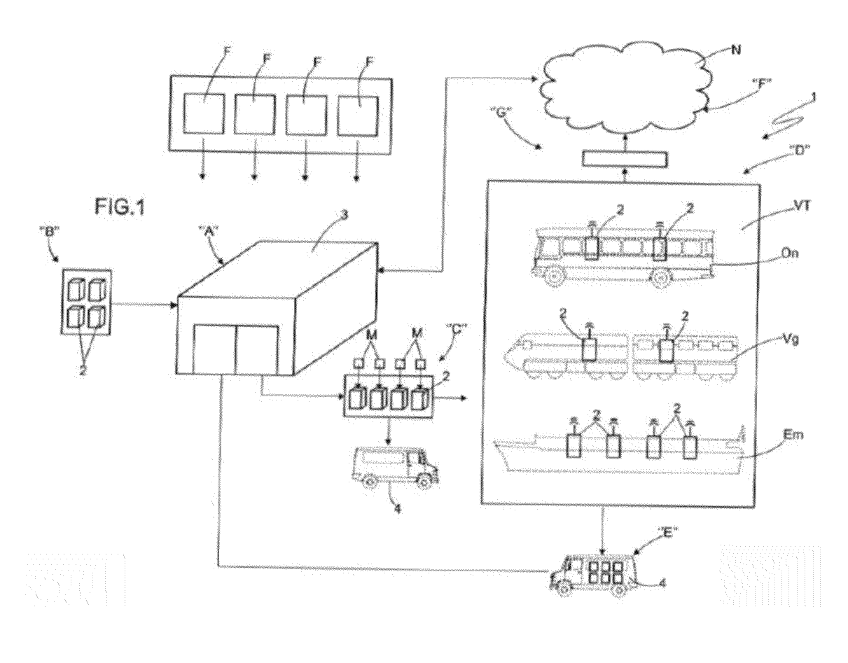

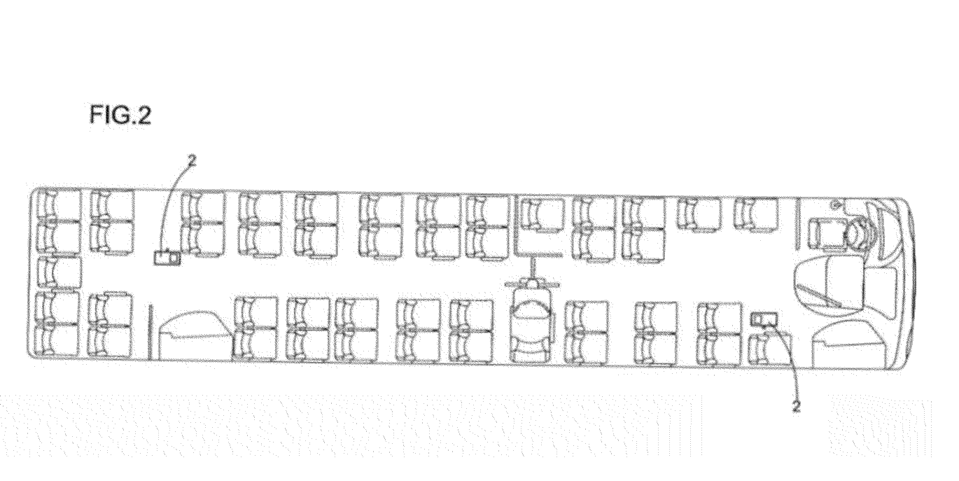

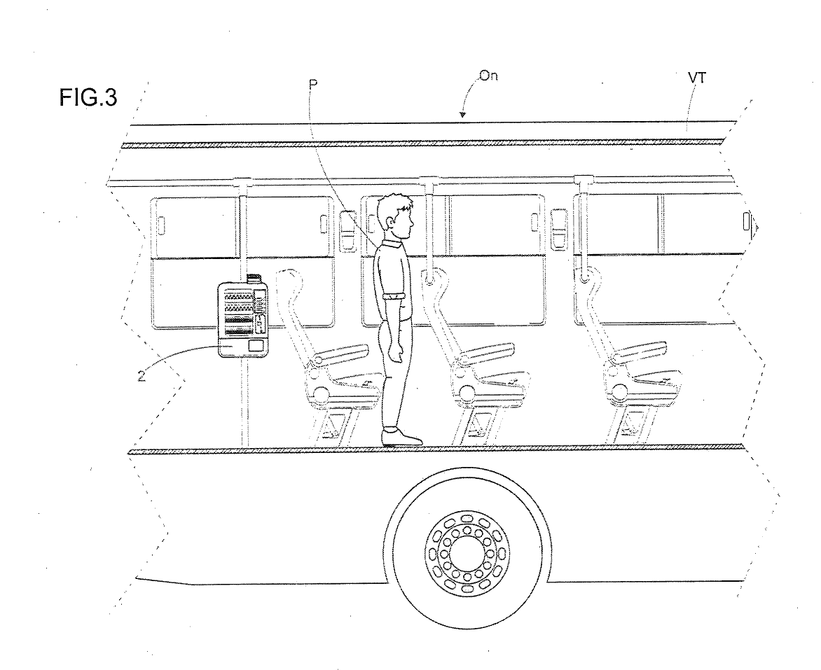

As it can be seen in FIGS. 1 to 3, the method (1) contains several operating stages and control that aim to keep at least 2 automatic vending machines (2) on board with diversified goods (M) in the vehicle of public transportation (VT), such as buses (On), subway cars (Vg) and trains, vessels (Em). The method can also keep automatic vending machines in other places and locations regardless of the several different models of existing transport vehicles, in order to offer goods to the passengers (P) inside (A) the vehicle of public transportation (VT).

The method includes the following stages:

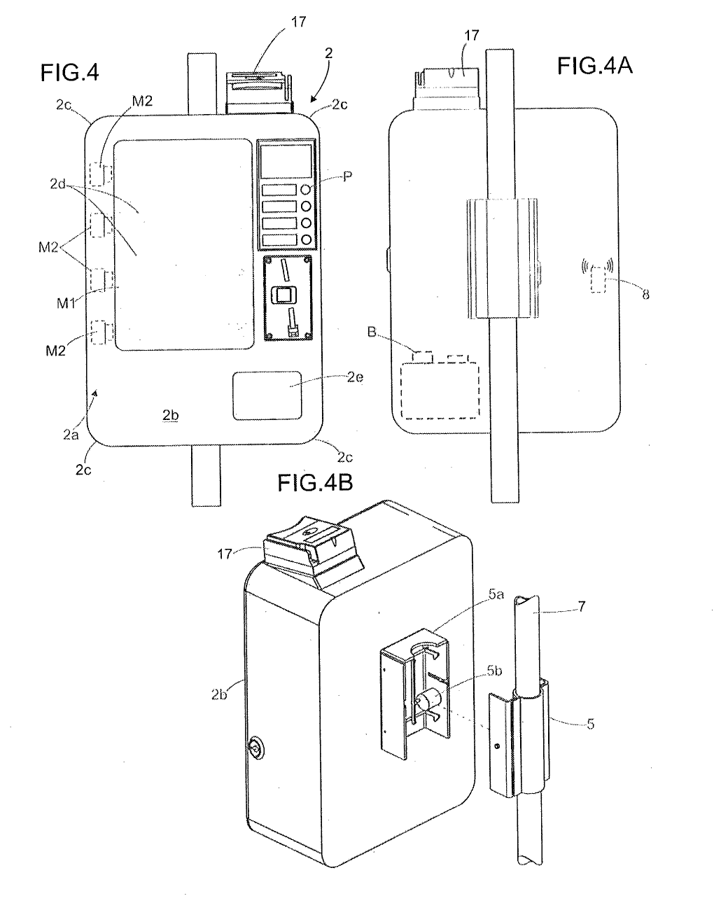

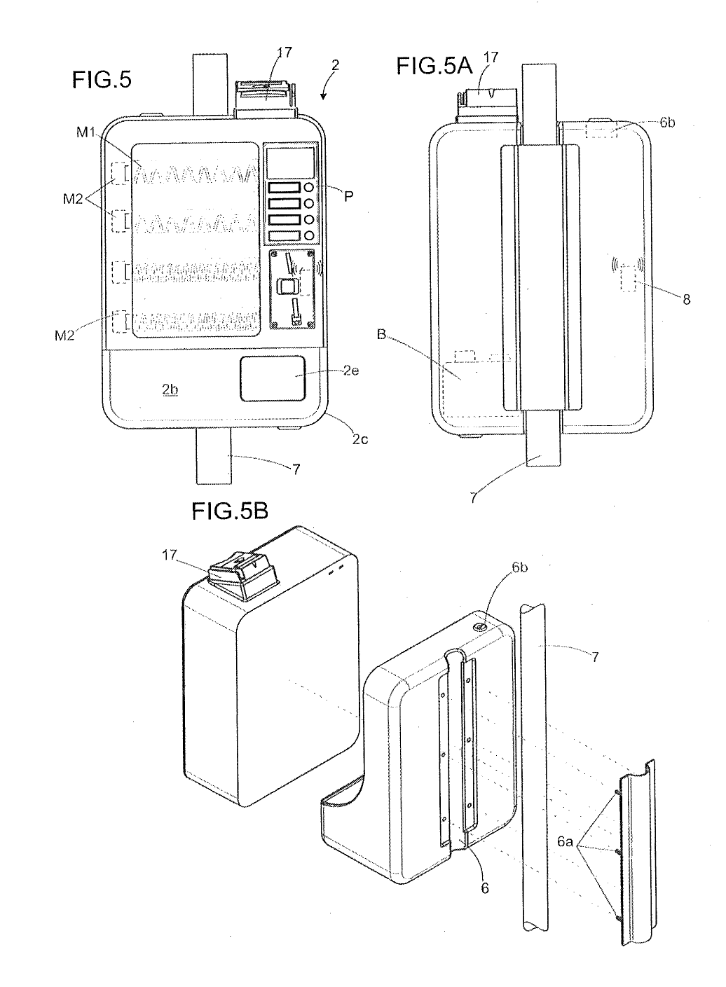

Stage A) providing at least one site (3) of distribution and logistics for receiving and storaging of several goods (M) acquired and coming from different manufacturers (F);
Stage B) manufacturing of automatic vending machines (2) with its own and appropriate settings to be installed and uninstalled on board and off board vehicle of public transportation (VT) or other appropriate places;
Stage C) Feeding of the automatic vending machines (2) with the goods (M) that were acquired from the different manufactures and then distributing all the multiple automatic vending machines (2) using vehicles of supply (4); Stage D) installing an equipment for installation of the automatic vending machines in the vehicles of public transportation (VT); as seen in FIGS. 4B and 5B; installing the brackets (5) and (6), e.g., in the vehicles (VT), in order to enable the assembly and fixture of the automatic vending machines (2), by configuring, the machines (2) and respective brackets (5) and (6), at the multiple mobile points of sale, hereinafter referred to MPOS;
Stage E) providing and installing the automatic vending machines (2) that are fed with the acquired from different manufacturers (F), on the equipment for installation of the automatic vending machines, in the vehicles of public transportation (VT);
Stage F) remotely controlling and collecting data of the volume and kind of sale of goods in the vehicles of public transportation (VT), in real time; in contact with the at least one site of distribution (3); managing the sale of goods in the MPOS in the machines (2), by having the data related to the collection of each machine (2), kind of sold goods (M), control of change/supply need of each empty or partially empty machine (2) by another one full of goods;
Stage G) providing replacement of the automatic vending machines, using vehicles of supply (4), according to the data collected in stage (F), the logistics controlling the circulation of the supply vehicles (4) the change and supply of the machines (2), as well as the return back to the site of distribution (3). The supply is made by change of empty or partially empty automatic vending machines (2) by other machines which is full of goods (M) in the MPOS. The replacement is performed by labor qualified and trained people who work within the vehicles of public transportation (VT), preferably in movement and with passengers, or in idle;

As seen in FIGS. 4, 4A, 4B, 5, 5A and 5B, the automatic vending machine (2) is especially developed to attend the method (1). It is presented in a shape of box (2a) with a front door (2b), both have all vertexes rounded (2c). Each machine (2) has compartments (2d) with devices to release the goods (M), such as Spring (M1) and engine (M2), in which the spring is rotated by the engine, when actuated by a user, allowing the goods (M) chosen from the dashboard or panel (P) to fall down in an access compartment (2e). As a sized dimensional reference, the machine (2) is presented with a maximum height of 35 cm (13,7795 inches), maximum width of 30 cm (11,811 inches) and maximum depth up to 12 cm (4,7244 inches).

The machine is attached to the vehicles of public transportation (VT) by a bracket (5) or cradle (6), which are previously fixed in a rail (7) within the vehicle (VT). In a first embodiment, the bracket is a hose clamp (5) with coupling lock (5a) and switch of secret (5b) or a cradle (6) with internal lock (6a) and switch of secret (6b). All this is done without needing to r interference with the transport vehicle (VT). After the coupling of the machine (2) in the bracket fixed to the rail (7), the vending machine, can be removed or changed at any time through the lock release (5a)/(6a) and safety key to allow the uncoupling.

The vending machine (2) includes a cashbox (17) that collects payments made with coins, bank notes, magnetic card, approaching card or any other technology taken on board.

The collected data of the volume and kind of sale of goods in each vehicle of public transportation is submitted to a cloud (N) by a device of data submission (8) of each vending machine (2). This data will be gathered and compiled, generating a report to be used by the management site (3) for logistic decisions.

The data submitted by device (8), is done by, mobile phone (GSM system or any other), which has the purpose to submit the data collected by every machine (2), to the cloud (N), in real time or delayed. The data provides, besides its identification and location, the collected price in a definite period during the day, kind of goods sold (M), the amount sold and the remaining amount of goods in each compartment (2d); among other data for remote logistic control by the site of distribution (3).

The submission of data to the cloud (N) by each machine (2) enables the compilation of information which will be used to generate the reporting of the sold goods (M), in a specific time, the days throughout the week, by type of transport vehicle, region of circulation in which the machine is installed, and etc. At the end, all the possible and necessary information that could be used upon by logistics, supply and stock system of marketable products are available for use or purchase.

The automatic vending machine (2) has a battery (B) fixed internally, which has a useful life of up to 24 hours and is loaded outside of the transport vehicle (VT), preferably at the site of distribution, not being necessary (even if available), any intervention in the transport vehicle for capturing energy and operation.

The automatic vending machine (2) can have a cooling system related to a small engine, both conventional, if necessary.

It should be understood that the preferred embodiments mentioned here are merely illustrative of the present invention. Numerous variations in design and use of the present invention may be contemplated in view of the following claims without straying from the intended scope and field of the invention herein disclosed.

1-8. (canceled)

9. A method for distribution, vending and replacement of goods through automatic vending machines installed on board of vehicles of public transportation, the method comprising the following operating stages:
(A) providing at least one management site for receiving, storing and managing the distribution and logistics of goods, acquired from different manufacturers;
(B) manufacturing automatic vending machines constructed and arranged to be installed and uninstalled on board and off board of vehicles of public transportation at appropriate places;
(C) Feeding of the automatic vending machines with the acquired goods;
(D) installing an equipment for installation of the automatic vending machines in the vehicles of public transportation;
(E) providing and installing the fed automatic vending machines on the equipment for installation of the automatic vending machines, in the vehicles of public transportation;
(F) remotely controlling and collecting data of the volume and kind of sale of goods in the vehicles of public transportation, in real time;
(G) replacing an empty or partially empty automatic vending machine by a fed automatic vending machines in the vehicles of public transportation, using vehicles of supply, according to the data collected in stage;
(H) bringing the replaced machine to the management site, providing supply of goods to the automatic vending machines,
wherein the replacement and supply is performed by qualified and trained labor;
and wherein the vehicle of public transportation is idling or in movement with passengers.

10. The method of claim 1, wherein the collected data of the volume and kind of sale of goods in the vehicles of public transportation is submitted to a cloud by a device of data submission of each vending machine, in real time or delayed, allowing for a compilation of the data and generating a report to be used by the management.

11. The method of claim 1, wherein the collected data provides identification and location of the vending machine, the collected price in a definite period during the day and week, the kind of goods sold, the amount of goods sold and the remaining amount of goods in each compartment.

12. The method of claim 2, wherein the collected data is submitted to the cloud using a mobile phone GSM System.

13. An automatic vending machine, for use with the method of claim 1, the machine comprising:
(i) a box with a front door, both having all vertexes rounded;
(ii) compartments with devices constructed and arranged to release the goods, the devices including a spring and an engine,
(iii) a dashboard or panel;
(iv) an access compartment;
(v) a cashbox linked to a device of data submission; enabling remotely controlling and collecting real time data of the volume and kind of goods sold in the vehicles of public transportation; the real time data transferred to the management site;
(vi) a battery having a useful life up to 24 hours, the battery charged by the vehicles of public transportation, if necessary;
wherein, for the release of the goods, the spring is rotated by the engine, actuated by the user, allowing the goods chosen from the dashboard or panel by the user, to fall down into the access compartment;

14. The automatic vending machine of claim 13, wherein the device of data submission of the automatic vending machine is a mobile phone GSM System.

15. The automatic vending machine of claim 13, wherein the machine has a maximum height of 35 cm (13,7795 inches), maximum width of 30 cm (11,811 inches) and a maximum depth of 12 cm (4,7244 inches).

16. The automatic vending machine of claim 13, wherein the real time data collected provides identification of location, collected price in a definite period during the day, kind of goods sold and amount and remaining amount of goods in each compartment,

17. An equipment for installation of automatic vending machines on board of vehicles of public transportation, at the appropriate place according to the method of claim 1, the equipment including a bracket and a cradle, constructed and arranged to be installed onto a rail in the vehicles of public transportation.

18. The equipment for installation of automatic vending machines on board of vehicles of public transportation, of claim 17, wherein alternatively the bracket comprises a hose clamp with a coupling lock and a switch of secret.

19. The equipment for installation of automatic vending machines on board of vehicles of public transportation of claim 17, further comprising an internal lock and a switch of secret, for locking and unlocking the cradle, enabling the replacement of the automatic vending machines without interference with the vehicles of public transportation.

20. The automatic vending machine of claim 13, the machine further including a cooling system with a small engine.
